(19) United States
(12) Patent Application Publication
(10) Pub. No.: US 2025/0280334 A1
(43) Pub. Date: Sep. 4, 2025

(54) APPARATUS AND METHOD FOR MEASUREMENT AND REPORT OF PHYSICAL LAYER REFERENCE SIGNAL IN NEXT-GENERATION MOBILE COMMUNICATION SYSTEM

(71) Applicant: Samsung Electronics Co., Ltd., Gyeonggi-do (KR)

(72) Inventors: June HWANG, Gyeonggi-do (KR); Seungri JIN, Gyeonggi-do (KR)

(21) Appl. No.: 19/066,858

(22) Filed: Feb. 28, 2025

(30) Foreign Application Priority Data
Feb. 29, 2024 (KR) 10-2024-0029908

(51) Int. Cl. H04W 36/00; H04W 36/08

(52) U.S. Cl. CPC H04W 36/0058; H04W 36/08

(57) ABSTRACT

The disclosure relates to a 5G or 6G communication system for supporting a higher data transmission rate. A method performed by a terminal in a wireless communication system includes receiving, from a base station, a control message including configuration information for an event triggered layer 1 (L1) measurement report including at least one of information on a resource for a channel state information reference signal (CSI-RS), at least one identity of the at least one candidate cell for a lower layer triggered mobility (LTM) associated with the CSI-RS, or information on at least one event for reporting a measurement result, measuring a serving cell and the at least one candidate cell for the LTM based on the configuration information, and transmitting, to the base station, the measurement result based on the information on the at least one event.

### CROSS-REFERENCE TO RELATED APPLICATION(S)

This application is based on and claims priority under 35 U.S.C. § 119 to Korean Patent Application No. 10-2024-0029908, filed on Feb. 29, 2024, in the Korean Intellectual Property Office, the disclosure of which is incorporated herein by reference in its entirety.

### BACKGROUND

### 1. Field

The disclosure relates generally to the operation of a terminal in a mobile communication system, and more particularly, to a method and apparatus for effectively performing measurement and reporting in the mobile communication system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as an LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR terminal Power Saving, Non-Terrestrial Network (NTN) which is terminal-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on terminal positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of terminal operation capability by utilizing ultra-high-performance communication and computing resources.

With the growth of mobile communication systems, a large variety of services can be provided, and methods for providing such services effectively are required.

### SUMMARY

Accordingly, an aspect of the disclosure is to eliminate unnecessary reporting procedures from occurring in a periodic reporting method when a terminal desires to perform lower layer measurement.

Another aspect of the disclosure is to provide a method by which a terminal that performs lower layer measurement can effectively perform reporting to a base station when specific conditions are satisfied.

In accordance with an aspect of the disclosure, a method performed by a terminal in a wireless communication system includes receiving, from a base station, a control message including configuration information for an event triggered layer 1 (L1) measurement report including at least one of information on a resource for a channel state information reference signal (CSI-RS), at least one identity of at least one candidate cell for a lower layer triggered mobility (LTM) associated with the CSI-RS, or information on at least one event for reporting a measurement result, measuring a serving cell and the at least one candidate cell for the LTM based on the configuration information, and transmitting, to the base station, the measurement result based on the information on the at least one event.

In accordance with an aspect of the disclosure, a method performed by a base station in a wireless communication system includes transmitting, to a terminal, a control message including configuration information for an event triggered layer 1 (L1) measurement report including at least one of information on a resource for a channel state information reference signal (CSI-RS), at least one identity of at least one candidate cell for a lower layer triggered mobility (LTM) associated with the CSI-RS, or information on at least one event for reporting a measurement result, and receiving, from the terminal, the measurement result based on the information on the at least one event, in case that a serving cell and the at least one candidate cell for the LTM are measured based on the configuration information.

In accordance with an aspect of the disclosure, a terminal in a wireless communication system includes a transceiver, and at least one processor configured to receive, from a base station via the transceiver, a control message including configuration information for an event triggered layer 1 (L1) measurement report including at least one of information on a resource for a channel state information reference signal (CSI-RS), at least one identity of at least one candidate cell for a lower layer triggered mobility (LTM) associated with the CSI-RS, or information on at least one event for reporting a measurement result, measure a serving cell and the at least one candidate cell for the LTM based on the configuration information, and transmit, to the base station via the transceiver, the measurement result based on the information on the at least one event.

In accordance with an aspect of the disclosure, a base station in a wireless communication system includes a transceiver, and at least one processor configured to transmit, to a terminal via the transceiver, a control message including configuration information for an event triggered layer 1 (L1) measurement report including at least one of information on a resource for a channel state information reference signal (CSI-RS), at least one identity of at least one candidate cell for a lower layer triggered mobility (LTM) associated with the CSI-RS, or information on at least one event for reporting a measurement result, and receive, from the terminal via the transceiver, the measurement result based on the information on the at least one event, in case that a serving cell and the at least one candidate cell for the LTM are measured based on the configuration information.

### BRIEF DESCRIPTION OF THE DRAWINGS

The above and other aspects, features, and advantages of certain embodiments of the disclosure will be more apparent from the following detailed description taken in conjunction with the accompanying drawings, in which:

FIG. 1 illustrates a structure of an LTE system.

FIG. 2 illustrates a radio protocol structure of an LTE system.

FIG. 3 illustrates a structure of a next-generation mobile communication system according to an embodiment;

FIG. 4 illustrates a radio protocol structure of a next-generation mobile communication system according to an embodiment;

FIG. 5 illustrates components of a terminal according to an embodiment;

FIG. 6 illustrates components of an NR base station according to an embodiment;

FIG. 7 illustrates a method in which a base station configures an object to measure to a terminal and the terminal performs measurement and report, according to an embodiment;

FIG. 8 illustrates a method in which a base station configures an object to measure to a terminal and the terminal performs measurement and report, according to an embodiment; and

FIG. 9 illustrates operations performed by a terminal according to an embodiment.

### DETAILED DESCRIPTION

Hereinafter, embodiments of the disclosure will be described in detail in conjunction with the accompanying drawings. A detailed description of known functions or configurations incorporated herein will be omitted for the sake of clarity and conciseness. The terms which will be described below are terms defined in consideration of the functions Herein, and may be different according to users, intentions of the users, or customs. Therefore, the definitions of the terms should be made based on the contents throughout the specification.

In the following description, terms for identifying access nodes and referring to network entities, messages, interfaces between network entities, various types of identification information, etc. are illustratively used for the convenience of description. Therefore, the disclosure is not limited by the terms as used below, and other terms referring to subjects having equivalent technical meanings may be used.

Herein, a base station refers to an entity performing resource allocation of a terminal, and may be at least one of a gNode B (gNB), an eNode B (eNB), a Node B, a BS, a radio access unit, a base station controller, or a node on a network. Also, a terminal may include a user equipment (UE), a mobile station (MS), a cellular phone, a smart phone, a computer, or a multimedia system capable of performing a communication function. A downlink (DL) refers to a wireless transmission path of a signal transmitted from a base station to a terminal, and an uplink (UL) refers to a wireless transmission path of a signal transmitted from a terminal to a base station. Although embodiments of the disclosure will be described below using an NR system as an example, such embodiments may also be applied to other communication systems having a similar technical background or channel type. The embodiments of the disclosure may be applied to other communication systems through some modifications within a range that does not significantly depart from the scope of the disclosure as will be apparent to a person skilled in the art.

Terms and names defined in the 3rd generation partnership project ((3GPP) long term evolution LTE) standards are used for the sake of convenience. However, the disclosure is not limited by these terms and names, and may be applied equally to systems that conform other standards. For example, the disclosure may be applied to the 3GPP 5GS/NR (5th generation mobile communication) standard.

Herein, an element included in the disclosure is expressed in the singular or the plural according to the embodiment. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

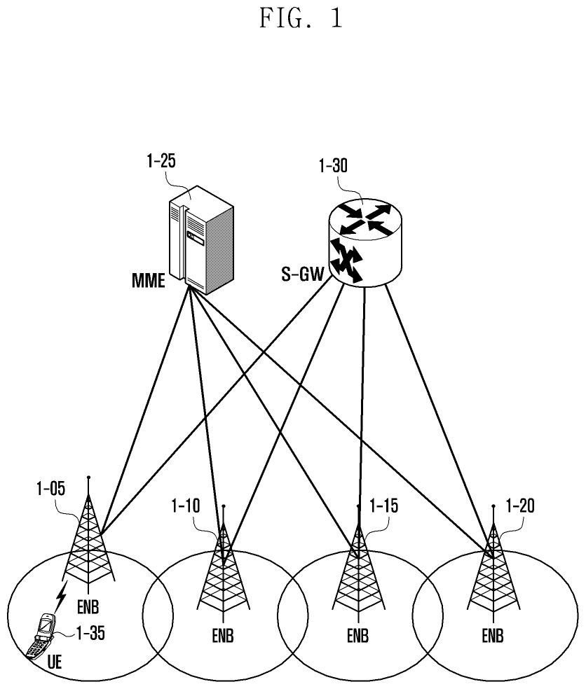

FIG. 1 illustrates a structure of a conventional LTE system.

Referring to FIG. 1, a radio access network of the LTE system may include next-generation base stations (BSs) such as evolved Node Bs, hereinafter referred to as eNBs, Node Bs 1-05, 1-10, 1-15 and 1-20, a mobility management entity (MME) 1-25, and a serving-gateway (S-GW) 1-30. A UE 1-35 may access an external network through the eNBs 1-05 to 1-20 and the S-GW 1-30.

The eNBs 1-05 to 1-20 may correspond to conventional Node Bs of a universal mobile telecommunications system (UTMS). The eNB is connected to the UE 1-35 through a radio channel and may perform a more complicated role than the conventional Node B. In the LTE system, all user traffic including a real time service such as a voice over Internet protocol (VOIP) through an Internet protocol can be serviced through a shared channel. Therefore, an apparatus for collecting state information on buffer states, available transmit power states, channel states, etc., of UEs and performing scheduling is required, and the eNBs 1-05 to 1-20 may serve as this apparatus. In general, one eNB may control a plurality of cells. For example, to implement a transfer rate of 100 Mbps, the LTE system may use orthogonal frequency division multiplexing (OFDM) as a radio access technology in a bandwidth of 20 MHz. An adaptive modulation and coding (AMC) scheme of determining a modulation scheme and a channel coding rate may be applied depending on the channel state of the UE. The S-GW 1-30 is an apparatus for providing a data bearer and may generate or remove the data bearer under the control of the MME 1-25. The MME is an apparatus for performing not only a mobility management function for the UE but also various control functions and may be connected to the plurality of eNBs 1-05 to 1-20.

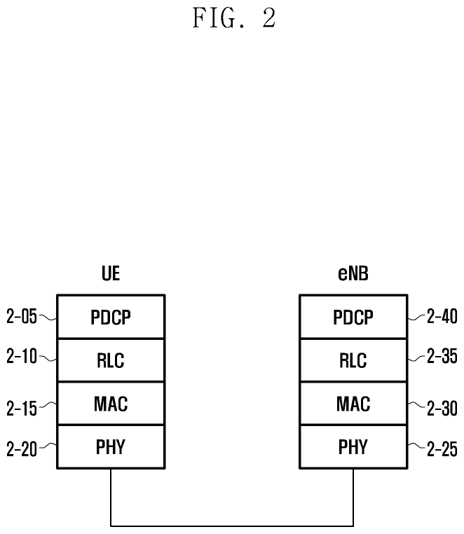

FIG. 2 illustrates a radio protocol structure of a conventional LTE system.

Referring to FIG. 2, the UE and the eNB may include packet data convergence protocols (PDCPs) 2-05 and 2-40, radio link controls (RLCs) 2-10 and 2-35, medium access controls (MACs) 2-15 and 2-30, respectively, in the radio protocol of the LTE system. The PDCPs 2-05 and 2-40 may perform operations such as IP header compression/decompression. The main functions of the PDCPs 2-05 and 2-40 can be summarized as follows.
Robust header compression and decompression
User data transmission
Sequential delivery of upper layer protocol data units (PDUs) at PDCP re-establishment procedure for RLC acknowledged mode (AM)
Reordering for split bearers in dual connectivity (DC) (only support for RLC AM): PDCP PDU routing for transmission and PDCP PDU reordering for reception)
Duplicate detection of lower layer SDUs at PDCP re-establishment procedure for RLC AM
Retransmission of PDCP SDUs at handover and, for split bearers in DC, of PDCP PDUs at PDCP data-recovery procedure, for RLC AM)
Ciphering and deciphering
Timer-based SDU discard in UL

The RLCs 2-10 or 2-35 may reconstruct a PDCP PDU to an appropriate size and perform an automatic repeat request (ARQ) operation or the like. The main functions of the RLCs 2-10 and 2-35 can be summarized as follows.
Data transmission of upper layer PDUs
Error correction through ARQ for AM data transfer
Concatenation, segmentation, and reassembly of RLC SDUs (only for UM and AM data transfer
Re-segmentation of RLC data PDUs for AM data transfer
Reordering of RLC data PDUs for unacknowledged mode (UM) and AM data transfer
Duplication detection for UM and AM data transfer
Protocol error detection for AM data transfer
RLC SDU discard for UM and AM data transfer
RLC re-establishment

The MACs 2-15 and 2-30 are connected to various RLC layer devices composed in one UE and may perform operations of multiplexing RLC PDUs to MAC PDU and de-multiplexing RLC PDUs from MAC PDU. The main functions of the MACs 2-15 and 2-30 can be summarized as follows.
Mapping between logical channels and transport channels
Multiplexing and demultiplexing of MAC SDUs belonging to one or multiple different logical channels into/from transport blocks TB delivered to/from the physical layer on transport channels
Scheduling information reporting
Error correction through HARQ
Priority handling between logical channels of one UE
Priority handling between UEs by dynamic scheduling
Multimedia broadcast multicast service (MBMS) identification
Transport format selection
Padding

The PHY layers 2-20 and 2-25 may perform operations of channel-coding and modulating higher layer data to generate an OFDM symbol and transmitting it through a radio channel or demodulating and channel-decoding an OFDM symbol received through a radio channel and transmitting it to a higher layer.

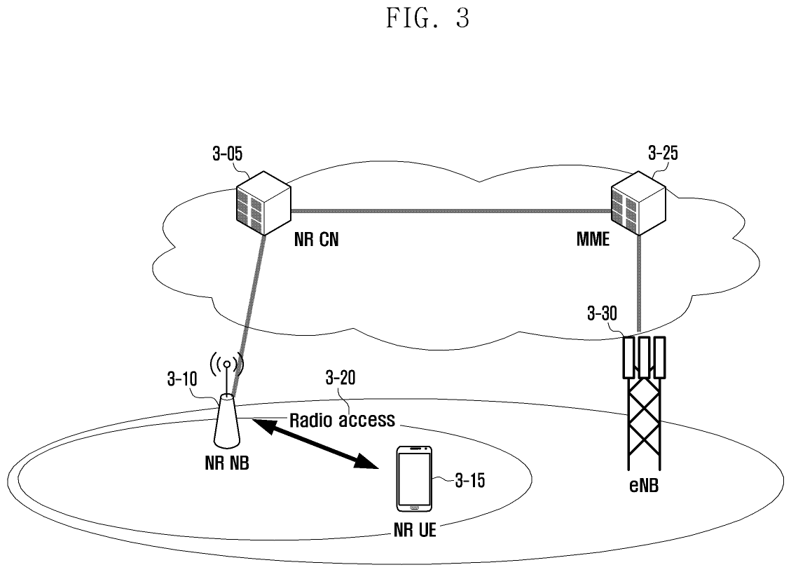

FIG. 3 illustrates a structure of a next-generation mobile communication system according to an embodiment.

Referring to FIG. 3, a radio access network of the next-generation mobile communication system (hereinafter referred to as NR or 5G) may include a new radio (NR) node B (NB) 3-10 (hereinafter referred to as an NR gNB or an NR BS) and an NR core network (CN) 3-05. An NR UE 3-15 (or a terminal) may access an external network through the NR gNB 3-10 and the NR CN 3-05.

The NR gNB 3-10 may correspond to an eNB in a conventional LTE system. The NR gNB 3-10 is connected to the NR UE 3-15 through a radio channel and may provide better service than the conventional node B. In the next-generation mobile communication system, all user traffic can be serviced through a shared channel. Therefore, an apparatus for collecting state information on buffer states, available transmit power states, channel states, etc., of UEs and performing scheduling is required, and the NR NB 3-10 may serve as this apparatus. One NR gNB may control a plurality of cells. In the next-generation mobile communication system, a bandwidth greater than the existing maximum bandwidth can be applied to implement super-high-speed data transmission compared to conventional LTE. OFDM is used as a radio access technology, and a beamforming technology can be further applied. An adaptive modulation and coding (AMC) scheme of determining a modulation scheme and a channel coding rate may be applied depending on the channel state of the UE. The NR CN 3-05 may perform functions such as mobility support, bearer configuration, and quality of service (QOS) configuration. The NR CN 3-05 is an apparatus for performing not only a mobility management function for the UE but also various control functions and may be connected to a plurality of BSs. The next-generation mobile communication system may be linked to the conventional LTE system, and the NR CN 3-05 may be connected to an MME 3-25 through a network interface. The MME 3-25 may be connected to an eNB 3-30, which is a conventional BS.

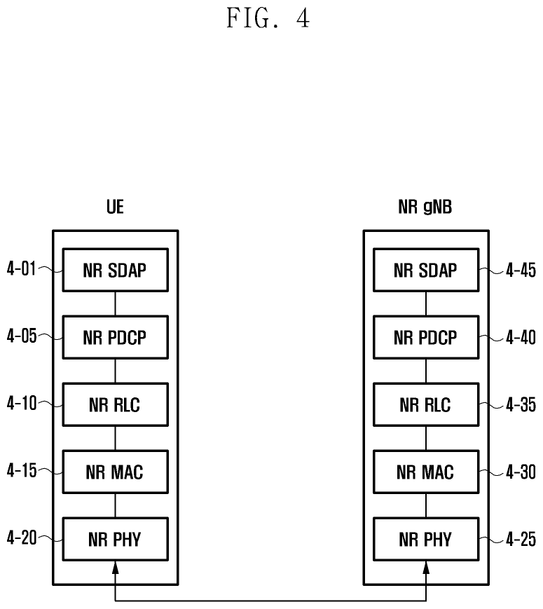

FIG. 4 illustrates a radio protocol structure of a next-generation mobile communication system according to an embodiment.

Referring to FIG. 4, the UE and the NR BS may include NR service data adaptation protocols (SDAPs) 4-01 and 4-45, NR PDCPs 4-05 and 4-40, NR RLCs 4-10 and 4-35, and NR MACs 4-15 and 4-30, respectively, in the radio protocol of the next-generation mobile communication system.

The main functions of the NR SDAPs 4-01 and 4-45 may include some of the following functions.
Transfer of user plane data
Mapping between a QoS flow and a data ratio bearer (DRB) for both DL and UL
Marking QoS flow ID in both DL and UL packets)
Reflective QoS flow to DRB mapping for the UL SDAP PDUs

With respect to an SDAP layer device, the UE may be configured through an RRC message whether to use a header of the SDAP layer device or a function of the SDAP layer device, for each PDCP layer device, each bearer, or each logical channel. If the SDAP header is configured, a 1-bit indicator of non-access stratum (NAS) reflective QoS of the SDAP header and a 1 bit-indicator of (access stratum (AS) reflective QoS may indicate that the UE can update or reconfigure mapping information about QoS flow and a data bearer in the UL and DL. The SDAP header may include QoS flow ID information indicating the QoS. The Qos information may be used as data processing priority, scheduling information, etc. to support a seamless service.

The main functions of the NR PDCPs 4-05 and 4-40 may include some of the following functions.
Robust header compression and decompression
User data transmission
Sequential delivery of upper layer PDUs
Non-sequential delivery of upper layer PDUs
PDCP PDU reordering for reception
Duplicate detection of lower layer SDUs
Retransmission of PDCP SDUs
Ciphering and deciphering
Timer-based SDU discard in UL

In the above description, the reordering function of the NR PDCP device may refer to a function of sequentially reordering PDCP PDUs received from a lower layer based on a PDCP sequence number (SN). The reordering function of the NR PDCP device may include a function of sequentially transferring the reordered data to a higher layer, a function of directly transferring the reordered data without regard to the order, a function of recording lost PDCP PDUs by reordering, a function of reporting the statuses of the lost PDCP PDUs to a transmitting side, or a function of requesting retransmission of the lost PDCP PDUs.

The main functions of the NR RLCs 4-10 and 4-35 may include some of the following functions.
Data transmission of upper layer PDUs
Sequential delivery of upper layer PDUs
Non-sequential delivery of upper layer PDUs
Error correction through ARQ
Concatenation, segmentation, and reassembly of RLC SDUs
Re-segmentation of RLC data PDUs
Reordering of RLC data PDUs
Duplicate detection
Protocol error detection
RLC SDU deletion
RLC re-establishment

In the above description, the sequential delivery of the NR RLC device may refer to a function of sequentially transferring RLC PDUs received from a lower layer to a higher layer. When one original RLC SDU is divided into a plurality of RLC SDUs and received, the sequential delivery of the NR RLC device may include a function of reassembling and transmitting the RLC SDUs.

The sequential delivery of the NR RLC device may include a function of reordering the received RLC PDUs based on an RLC SN or a PDCP SN, a function of recording lost RLC PDUs by reordering, a function of reporting the statuses of the lost RLC PDUs to a transmitting side, and a function of requesting retransmission of the lost RLC PDUs.

When there is a lost RLC SDU, the sequential delivery of the NR RLC device may include a function of sequentially transferring only RLC SDUs preceding the lost RLC SDU to the higher layer.

If a predetermined timer expires even when there is a lost RLC SDU, the sequential delivery of the NR RLC device may include a function of sequentially transferring all RLC SDUs received before the timer starts to the higher layer.

If a predetermined timer expires even when there is a lost RLC SDU, the sequential delivery of the NR RLC device may include a function of sequentially transferring all RLC SDUs received up to that point in time to the higher layer.

The NR RLC device may process the RLC PDUs sequentially in the order of reception thereof regardless of the out-of-sequence delivery and transfer the RLC PDUs to the NR PDCP device.

In the case of receiving a segment, the NR RLC device may use segments stored in the buffer or receive segments later, reassemble them into a complete one RLC PDU, and transmit it to the NR PDCP device.

The NR RLC layer may not include a concatenation function, and this function may be performed by the NR MAC layer or replaced with a multiplexing function of the NR MAC layer.

In the above description, the non-sequential delivery of the NR RLC device may refer to a function of transferring RLC SDUs received from a lower layer directly to a higher layer regardless of the order of the RLC SDUs. When one original RLC SDU is divided into a plurality of RLC SDUs and received, the non-sequential delivery of the NR RLC device may include a function of reassembling and transmitting the RLC SDUs. The non-sequential delivery of the NR RLC device may include a function of storing RLC SNs or PDCP SNs of the received RLC PDUs, reordering them, and recording lost RLC PDUs.

The NR MACs 4-15 and 4-30 may be connected to a plurality of NR RLC layer devices composed in one apparatus, and main functions of the NR MACs 4-15 and 4-30 may include some of the following functions.
Mapping between logical channels and transport channels
Multiplexing and demultiplexing of MAC SDUs
Scheduling information reporting
Error correction through HARQ
Logical channel priority handling
Priority handling between UEs by dynamic scheduling
MBMS service identification
Transport format selection
Padding

The NR PHY layers 4-20 and 4-25 may perform operations of channel-coding and modulating higher layer data to generate an OFDM symbol and transmitting it through a radio channel or demodulating and channel-decoding an OFDM symbol received through a radio channel and transmitting it to a higher layer.

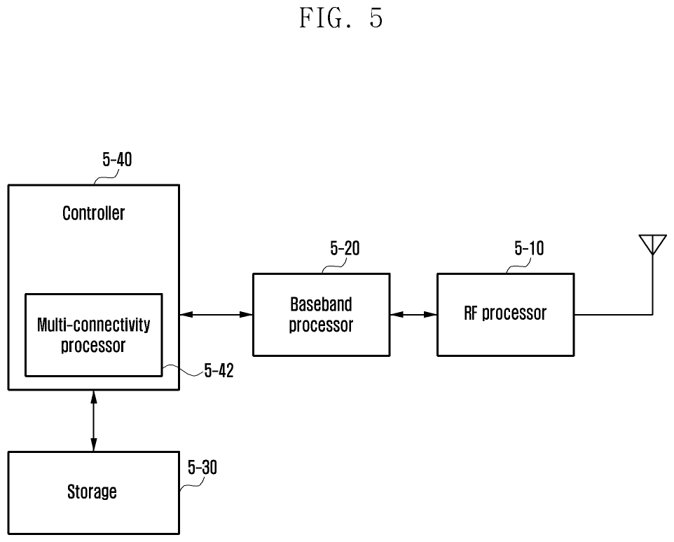

FIG. 5 illustrates components of a terminal according to an embodiment.

Referring to FIG. 5, the terminal may include a radio frequency (RF) processor 5-10, a baseband processor 5-20, a storage 5-30, and a controller 5-40.

The RF processor 5-10 performs functions for transmitting and receiving signals via radio channels, such as band conversion and amplification of the signals. That is, the RF processor 5-10 up-converts a baseband signal, provided from the baseband processor 5-20, into an RF band signal and then transmits the RF band signal via an antenna, and it down-converts an RF band signal, received via the antenna, into a baseband signal. For example, the RF processor 5-10 may include a transmission filter, a reception filter, an amplifier, a mixer, an oscillator, a digital-to-analog converter (DAC), an analog-to-digital converter (ADC), or the like. Although only one antenna is illustrated in FIG. 5, the terminal may include a plurality of antennas. The RF processor 5-10 may include a plurality of RF chains. The RF processor 5-10 may perform beamforming. For beamforming, the RF processor 5-10 may respectively adjust phases and intensities of signals to be transmitted or received via a plurality of antennas or antenna elements. The RF processor 5-10 may perform a MIMO operation and may receive a plurality of layers in the MIMO operation.

The baseband processor 5-20 performs a conversion function between a baseband signal and a bit stream in accordance with physical layer specifications of a system. For example, upon data transmission, the baseband processor 5-20 generates complex symbols by encoding and modulating a transmission bit stream. Upon data reception, the baseband processor 5-20 restores a received bit stream by demodulating and decoding a baseband signal provided from the RF processor 5-10. For example, in the case of complying with an OFDM scheme, upon data transmission, the baseband processor 5-20 generates complex symbols by encoding and modulating a transmission bit stream, maps the complex symbols to subcarriers, and then constructs OFDM symbols by performing inverse fast Fourier transform (IFFT) and cyclic prefix (CP) insertion. Upon data reception, the baseband processor 5-20 segments a baseband signal provided from the RF processor 5-10 into OFDM symbol units, restores signals mapped to subcarriers by performing fast Fourier transform (FFT), and then restores a received bit stream by demodulating and decoding the signals.

The baseband processor 5-20 and the RF processor 5-10 transmit and receive signals as described above. Thus, the baseband processor 5-20 and the RF processor 5-10 may be called a transmitter, a receiver, a transceiver, or a communicator. In addition, at least one of the baseband processor 5-20 or the RF processor 5-10 may include a plurality of communication modules to support a plurality of different radio access technologies. Also, at least one of the baseband processor 5-20 or the RF processor 5-10 may include different communication modules to process signals of different frequency bands. For example, the different radio access technologies may include wireless local area network (LAN), cellular network, etc. The different frequency bands may include a super-high frequency (SHF) (e.g., 2.NRHz, NRHz) band and an mm Wave (e.g., 60 GHz) band.

The storage 5-30 stores default programs, application programs, and data, such as configuration information, for operations of the terminal. In particular, the storage 5-30 may store information related to a second access node that performs wireless communication using a second radio access technology. The storage 5-30 provides the stored data upon request by the controller 5-40.

The controller 5-40 controls overall operations of the terminal. For example, the controller 5-40 transmits and receives signals through the baseband processor 5-20 and the RF processor 5-10. The controller 5-40 records and reads data on and from the storage 5-30. To this end, the controller 5-40 may include at least one processor. For example, the controller 5-40 may include a communication processor for controlling communications and an application processor (AP) for controlling an upper layer such as an application program. The controller 5-40 includes a multi-connectivity processor 5-42.

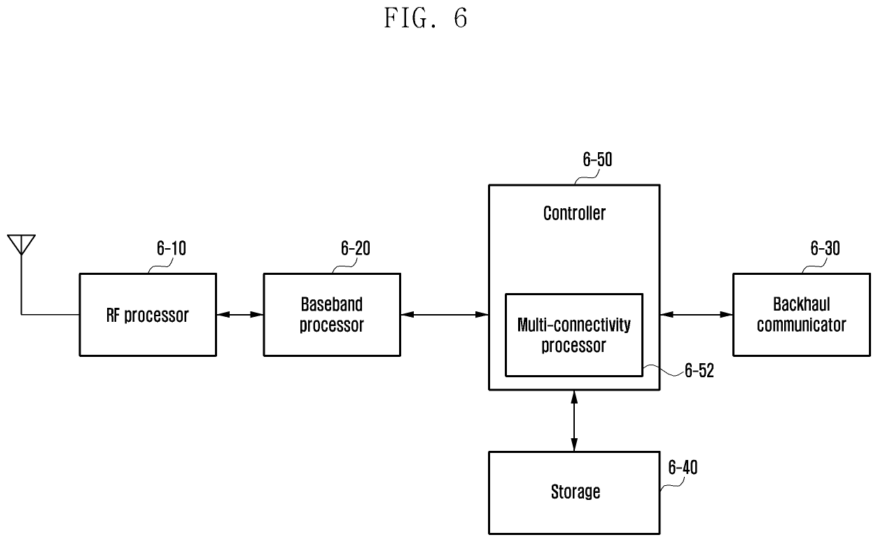

FIG. 6 illustrates components of an NR BS according to an embodiment.

Referring to FIG. 6, the BS may include a RF processor 6-10, a baseband processor 6-20, a backhaul communicator 6-30, a storage 6-40, and a controller 6-50.

The RF processor 6-10 performs functions for transmitting and receiving signals via radio channels, such as band conversion and amplification of the signals. That is, the RF processor 6-10 up-converts a baseband signal, provided from the baseband processor 6-20, into an RF band signal and then transmits the RF band signal via an antenna, and down-converts an RF band signal, received via an antenna, into a baseband signal. For example, the RF processor 6-10 may include a transmission filter, a reception filter, an amplifier, a mixer, an oscillator, a DAC, an ADC, or the like. Although only one antenna is illustrated in FIG. 6, the RF processor 6-10 may include a plurality of antennas. The RF processor 6-10 may include a plurality of RF chains. The RF processor 6-10 may perform beamforming. For beamforming, the RF processor 6-10 may respectively adjust phases and intensities of signals to be transmitted or received via a plurality of antennas or antenna elements. The RF processor may perform a DL MIMO operation by transmitting one or more layers.

The baseband processor 6-20 a conversion function between a baseband signal and a bit stream in accordance with physical layer specifications of a first radio access technology. For example, upon data transmission, the baseband processor 6-20 generates complex symbols by encoding and modulating a transmission bit stream. Also, upon data reception, the baseband processor 6-20 restores a received bit stream by demodulating and decoding a baseband signal provided from the RF processor 6-10. For example, in the case of complying with the OFDM scheme, upon data transmission, the baseband processor 6-20 generates complex symbols by encoding and modulating a transmission bit stream, maps the complex symbols to subcarriers, and then constructs OFDM symbols by performing IFFT and CP insertion. Upon data reception, the baseband processor 6-20 segments a baseband signal provided from the RF processor 6-10 into OFDM symbol units, restores signals mapped to subcarriers by performing FFT, and then restores a received bit stream by demodulating and decoding the signals. The baseband processor 6-20 and the RF processor 6-10 transmit and receive signals as described above. Thus, the baseband processor 6-20 and the RF processor 6-10 may be referred to as a transmitter, a receiver, a transceiver, a communicator, or a wireless communicator.

The backhaul communicator 6-30 provides an interface for communicating with other nodes in the network. The backhaul communicator 6-30 converts a bit stream transmitted from a main BS to any other node, for example, an auxiliary BS, a core network, etc., into physical signals, and converts physical signals received from such other node into a bit stream.

The storage 6-40 stores default programs, application programs, and data, such as configuration information, for operations of the BS. In particular, the storage 6-40 may store, for example, information about bearers assigned for a connected terminal, measurement results reported from the connected terminal, and the like. The storage 6-40 may store criteria information used to determine whether to provide or release multi-connectivity to or from the terminal. The storage 6-40 provides the stored data upon request by the controller 6-50.

The controller 6-50 may control overall operations of the BS. For example, the controller 6-50 transmits and receives signals through the baseband processor 6-20 and the RF processor 6-10 or through the backhaul communicator 6-30. The controller 6-50 records and reads data on and from the storage 6-40. To this end, the controller 6-50 may include a multi-connectivity processor 6-52.

In conventional Layer 1 (L1) measurement and reporting, a configured terminal can measure the corresponding channel state information (CSI) specific reference signal (RS), and perform a periodic report, a semi-persistent report, or an aperiodic report. The availability/unavailability of each CSI-RS resource configuration and corresponding report configuration are as follows. Basically, periodic CSI-RS supports periodic CSI report, semi-persistent CSI report, and aperiodic CSI report, semi-persistent CSI-RS supports semi-persistent CSI report and aperiodic CSI report, and aperiodic CSI-RS supports only aperiodic CSI report. That is, the form of report becomes available/unavailable depending on whether the form of resource is sufficient in terms of time.

Table 1 below is related to Triggering/Activation of CSI Reporting for the possible CSI-RS Configurations.

TABLE 1

| Resource | | | |
|---|---|---|---|
| Configuration | Report Configuration | | |
| CSI-RS | Periodic | Semi-Persistent | Aperiodic |
| Configuration | CSI | CSI | CSI |
| Periodic | No dynamic | Reporting on a | Triggered by |
| CSI-RS | triggering/ | physical UL control | DCI, |
| | activation | channel (PUCCH): | additionally |
| | | Triggering by | by MAC CE |
| | | MAC CE | |
| | | Reporting on a | |
| | | physical UL shared | |
| | | channel (PUSCH): | |
| | | Triggering by DCI | |
| Semi- | Not | Reporting on PUCCH: | Triggered by |
| Persistent | supported | Triggering by | DCI, |
| CSI-RS | | MAC CE | additionally |
| | | Reporting on PUSCH: | by MAC CE |
| | | Triggering by DCI | |
| Aperiodic | Not | Not | Triggered by |
| CSI-RS | supported | supported | DCI, |
| | | | additionally |
| | | | by MAC CE |

However, in measurement and report operations for the above resource and report configurations, measurements must always be performed within a fixed time and reports must always be performed through a fixed time or cycle. Therefore, the above measurement and report operations may not be performed conditionally based on an event. Accordingly, an operation is required to perform CSI reporting only when a condition for a specific situation that the BS must know is satisfied.
Herein, the following is disclosed for the event triggered CSI report.
Define the object to measure for event triggered report
Define the event to evaluate
Quantity derivation
Evaluation method with the quantity
Define Reporting procedure
Reporting periodicity
Report contents
Signaling

For the object to measure in the event triggered CSI report, the following options are possible.

### Option 1.

Only RSs transmitted within one cell to which the CSI-report configuration is applied may be considered. In this case, RSs indicated using legacy CSI-resourceConfig ID may be considered. (A difference according to the disclosure is that event triggered may be added to the CSI report type configuration associated with the CSI-resourceConfig ID.)

The above RSs may be transmitted from the target cell which is delivered the CSI-measConfig indicating the event triggered report or indicated in the CSI-measConfig.

When indicating to the terminal, the network may indicate the RS by a combination of resources and/or a resource set in the CSI-resource configuration existing in the CSI-measConfig.

Alternatively, an indicator indicating the type of the event triggered report may be linked to a specific CSI-RS resource or resource set and indicated to the terminal. The specific CSI-RS resource may be used only for the event triggered report. As in the conventional method, a resource config ID and an event triggered report type indicator may be linked. The same resource may be linked to an event triggered or periodic/aperiodic/semi-persistent report and indicated to the terminal.

The above method may be used for intra cell beam management, as will be further described herein.

The RS at issue is in a cell which configures the CSI-measConfig.

Using resource set and/or resource ID combination in CSI-measConfig

Within resource, event triggered type can be indicated (i.e., resource only specific to the event triggered case)

Otherwise, legacy resource config ID can be referred in the report Config as for the event trigger type. (i.e., common resource for event triggered and periodic report) Can be used for intra cell beam management without signaling overhead.)

### Option 2. Across Serving Cells

One object to measure may be created as a combination of RSs for CSI transmitted within each serving cell. For example, it may be composed of a combination of CSI-RS resource/resource set and/or synchronization signal block (SSB) of each serving cell within CSI-measConfig configured in each serving cell.

Each RS for CSI which is the object to measure must be indicated in CSI-measConfig or CSI-reportConfig configured to a serving cell to which a measurement report of the object to measure is transmitted. When the RS for CSI is indicated, it must be linked with the serving cell that transmits the RS for CSI. For linking with the serving cell, a serving cell index may be used. The object to measure may be configured to the terminal as servCellIndex+CSI-RS resource (set) ID in CSI RS resource Config in that cell.

Through the above configuration, the terminal may perform beam management between serving cells. When a specific beam of a specific serving cell has a signal strength less than or equal to a specific level, the terminal may transmit the corresponding content to any serving cell. Alternatively, when the signal strength of a specific serving cell is less than or equal to a specific level compared to the signal strength of any other serving cell, the terminal may perform a cell switch operation to the other serving cell. (Can be used for beam management across serving cells, or cell switch among serving cells (SpCell to SCell, vice versa).)

An indicator indicating the type of the event triggered report may be linked with the specific CSI-RS resource or resource set and indicated to the terminal. The specific CSI-RS resource may be used only for the event triggered report. Alternatively, as in the conventional method, the resource config ID and the event triggered report type indicator may be linked. The same resource may be linked with event triggered or periodic/aperiodic/semi-persistent report and indicated to the terminal.

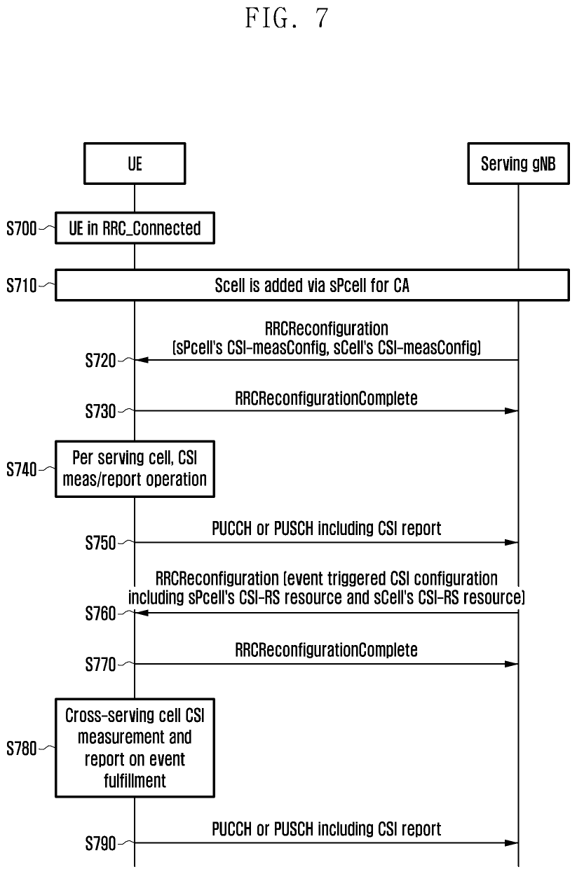

FIG. 7 illustrates a method in which a BS configures an object to measure to a terminal and the terminal performs measurement and report, according to an embodiment.

Referring to FIG. 7, the terminal existing in an RRC connected state in step S700 may perform an operation of adding SCell via SpCell for carrier aggregation (CA) in step S710.

In step S720, the BS (i.e., serving gNB) may transmit an RRCReconfiguration message to the terminal. At this time, a configuration for a CSI-RS transmitted from the serving cell (SpCell and SCell) may be transmitted in a CSI resource configuration of CSI meas Config of each serving cell configuration of the RRCReconfiguration message. The BS may transmit a CSI measurement report configuration in each serving cell together with the above configuration.

In step S730, the terminal that receives the RRCReconfiguration message may transmit an RRC reconfiguration complete message to the BS.

In step S740, the terminal may measure CSI-RS per serving cell based on the received information. The terminal may transmit a report on the measurement to each cell based on a configured report format. For example, in step S750, the terminal may transmit a PUCCH or PUSCH including a CSI report.

Thereafter, the serving BS may form a new object to measure by combining some of RS resources and/or a resource set from the previously transmitted CSI-RS configurations in respective cells. The object to measure may be used for the purpose of event triggered CSI measurement and report.

Alternatively, the per serving cell's CSI meas configuration and the event triggered CSI configuration (e.g., cross serving cell CSI-RS configuration) may be included together in one RRCReconfiguration message rather than the two sequential RRCReconfiguration messages, and transmitted to the terminal. In this case, the terminal may perform the per serving cell CSI meas/report operation and the cross-serving cell CSI meas/report operation simultaneously. In this case, the cross-serving cell CSI meas/report may perform the event triggered report operation as previously defined.

For example, in step S760, the BS may transmit to the terminal an RRC reconfiguration message that contains the event triggered CSI configuration including SpCell's CSI-RS resource and SCell's CSI-RS resource.

In step S770, the terminal that receives the RRCReconfiguration message may transmit an RRC reconfiguration complete message to the BS.

In step S780, the terminal may perform cross-serving cell CSI measurement and reporting based on event satisfaction. In step S790, the terminal may transmit a PUCCH or PUSCH including a CSI report.

### Option 3. Across Anonymous Cells

One object to measure may be created as selected CSI RSs (and resources or a resource set including them) from multiple cells, regardless of the serving cell. In this case, the type of each RS may be SSB only, CSI-RS only, or a combination of SSB and CSI-RS. Also, in one example, the object to measure may be created as a combination of resources and/or a resource set, which denote time and frequency positions of each RS. When the terminal needs to use this object to measure, each RS must be combined with the index of the corresponding cell (or the absolute cell id, e.g., physical cell identifier (PCI) and/or absolute frequency channel number (AFRCN) or cell global identity (CGI), Alternatively, in case of a cell already setup for a specific purpose, the ID of that cell (e.g., in case of LTM, the corresponding LTM candidate id)) and signaled to the terminal. For example, the object to measure may be configured through a combination of an index of SpCell, a resource and/or resource set ID of a CSI-RS configured in the SpCell, a cell ID in a PCI with ARFCN or a specific configuration of any other cell, and a resource and/or resource set ID of a CSI-RS in that cell. Alternatively, an indicator indicating the type of the event triggered report may be linked with a specific CSI-RS resource or resource set and indicated to the terminal. (For example, a specific resource may be used only for the event triggered report). Alternatively, as in the conventional method, a resource config ID and an event triggered report type indicator may be linked. For example, the same resource may be linked with an event triggered or periodic/aperiodic/semi-persistent report and indicated to the terminal.

Additionally, when the RS type includes a CSI-RS other than SSB, each CSI-RS resource configuration must be signaled prior to the above configuration or at the same stage, so that the terminal can identify each RS.

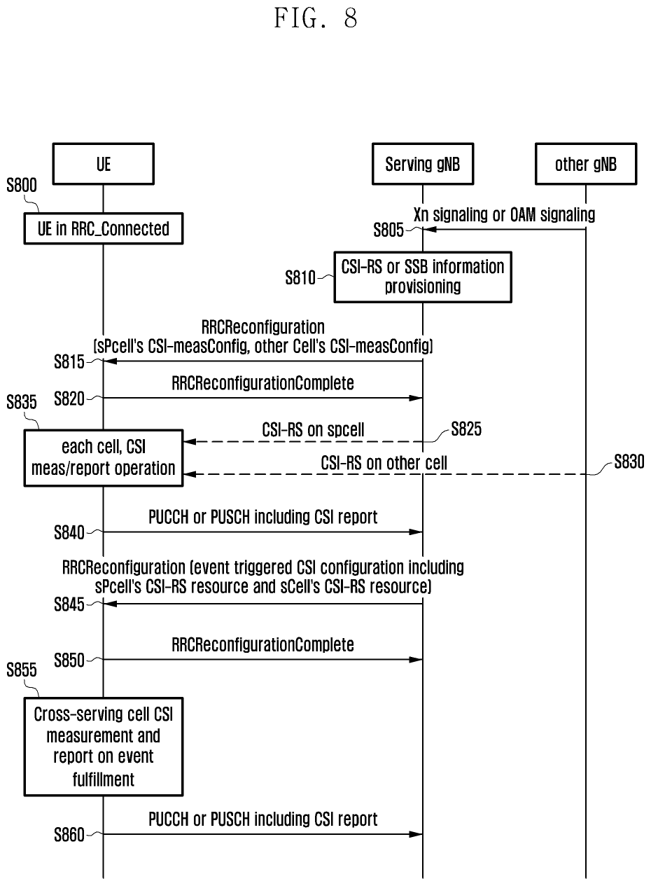

FIG. 8 illustrates a method in which a BS configures an object to measure to a terminal and the terminal performs measurement and report, according to an embodiment.

Referring to FIG. 8, the terminal may be configured with CSI-RS transmitted in its own cell (e.g., SpCell) through a CSI-measConfig field for its own cell from the BS (i.e., serving gNB). The terminal may measure the configured CSI-RS and transmit a report according to the report configuration included in CSI-measconfig to its own cell (e.g., SpCell). Prior to this, the serving gNB may pre-acquire information about transmission of SSB and/or CSI-RS operated in each cell for other gNBs. This information related to the other gNBs may be requested and received from neighboring gNBs by the serving gNB through an Xn message, or the serving gNB may receive information maintained by an OAM server, in which case the information may be received through a PDU connection between the gNB and the OAM server.

For example, in step S800, the terminal may be in an RRC connected state. In step S805, the serving gNB may receive information about transmission of SSB and/or CSI-RS operated in each cell from other gNBs through Xn signaling or OAM signaling. In step S810, the serving gNB may perform CSI-RS or SSB information provisioning.

Thereafter, when event triggered CSI meas/report are configured, in an RRCReconfiguration message, a new object to measure may be configured by combining some or all of RSs for CSI transmitted from SpCell and some or all of RSs for CSI transmitted from other cells.

In step S815, the serving gNB may transmit to the terminal the RRCReconfiguration message that contains a CSI measurement configuration of SpCell and a CSI measurement configuration of at least one of other cells. The serving gNB may transmit a CSI measurement report configuration of each serving cell together with the measurement configuration.

In step S820, the terminal that receives the RRCReconfiguration message may transmit an RRC reconfiguration complete message to the serving gNB.

In steps S825 and S830, the terminal may receive CSI-RS from at least one of the serving gNB and other gNBs through SpCell or other cells.

In step S835, the terminal may measure the CSI-RS per serving cell based on the received information. The terminal may transmit a report on the measurement to each cell based on a configured report format. For example, in step S840, the terminal may transmit a PUCCH or PUSCH including a CSI report.

In Option 3, similar to Option 2, when an event through the measurement is satisfied, the terminal may be included and configured in the event triggered CSI configuration of the RRCReconfiguration message for the serving cell that is a specific reporting target.

For example, in step S845, the serving gNB may transmit to the terminal an RRC reconfiguration message that contains the event triggered CSI configuration including SpCell's CSI-RS resource and SCell's CSI-RS resource.

In step S850, the terminal that receives the RRCReconfiguration message may transmit an RRC reconfiguration complete message to the serving gNB.

In step S855, the terminal may perform cross-serving cell CSI measurement and report based on event satisfaction. In step S860, the terminal may transmit a PUCCH or PUSCH including a CSI report to the serving gNB.

The above Options 1, 2, and 3 may all coexist and be configured to the terminal by the BS. The objects to measure may be configured to the terminal with a separate ID such as an event triggered CSI-resource config ID.

### Evaluation Metric Configuration

Disclosed is an embodiment for an event evaluation metric (or quantity) when measurement is performed based on the object to configure.

A representative value calculation per quantity, such as a method of deriving a quantity used for evaluation from measurement samples of RS which is the object to measure is now described.

Option 1-1. Consolidation per cell may be performed on the RS resource and/or resource set of the object to measure. In this case, a linear average may be performed on the measurement values of all/some of the RSs being transmitted in a specific cell among RSs which are the objects to measure. (In the case of typical ICBMs, consolidation per cell may not be performed.)

At this time, only those exceeding a specific reference signal received power/reference signal received quality (RSRP/RSRQ) may be considered as a selection criterion for RSs per cell. (A corresponding threshold value may be configured by the network to the terminal (for example, using the CSI report configuration)). The BS may transmit the threshold value to the terminal when configuring the event triggered report to the terminal, and the terminal may measure the corresponding RSs and consider only the RSs whose received strength exceeds the threshold value to consider the average value of the received strengths as the measurement value of the corresponding cell.

In addition, when performing the consolidation per cell, the BS may configure the CSI meas configuration to the terminal including the corresponding indicator.

Option 2-1. The measurement value may be considered for each RS.

In this case, as in Option 1-1, the network may transmit a specific RS reception threshold value to the terminal. Then, the terminal may consider the received signal strength of the RS in the evaluation of condition satisfaction if it is greater than or equal to the threshold value. In this case, the condition may be a comparative determination between the RS and another RS, the RS and an RS of other cell, or the RS and a consolidated signal strength of other cell.

A time average may be applied to the values of the above Options 1-1 and 2-1. The corresponding time window value may be configured. For example, in Option 1-1, when the signal strength value of the consolidated cell is generated n times, and the time window value is configured to n times for the terminal, the average value of the n signal strength values may be the final condition determination value. In Option 2-1, the average value of the n signal strength values of a specific RS may be considered as the signal strength value for the condition determination of the specific RS. The time window may be expressed as the number of samples to be considered, and when assuming the generation of samples in a specific cycle, it may be signaled to the terminal as the absolute time value.

In addition, a moving average may be performed for the above Options 1-1 and 2-1. A linear combination of the time average value or instant value at a specific time or specific time point and the latest measurement result value may be performed. For example, in the case of “current cell-specific or beam-specific metric=(1−a)*(time average or instant value)+a*(value of the most recent measurement sample), the value of ‘a’ may be signaled to the terminal. The quantities for which the above operation is possible are L1-RSRP and L1-SINR.

Other quantities may be a representative value as the derived value or the time average/moving average as described above may be possible.

### Condition Evaluation

For the representative value per cell (Option 1-1) in the previously proposed representative value derivation for each quantity, a threshold value or a relative value (offset) of each quantity may be considered. For the serving cell that is the target for reporting the event triggered CSI report, a case where the serving cell is greater than or less than a specific given threshold value, or where another cell (another specific serving cell, another serving cell (anonymous serving cell), another specific cell, or another cell (anonymous cell)) relative to that serving cell is greater than or less than an offset may be considered. Cases expressed in the following expressions may be considered as when the condition is satisfied or the event triggered cases.

For example, serving cell representative value>threshold, serving cell representative value<threshold, threshold 1<serving cell representative value<threshold 2

For example, serving cell 1 representative value>serving cell 2 representative value+offset, serving cell 1<serving cell 2 representative value+offset, serving cell 1+offset<serving cell 2

For example, serving cell 1 representative value>specific cell 1 representative value+offset.

In the above expressions, the serving cells on the right side of the inequality may be replaced with any non-serving cell. For example, the signal strength may be compared between the serving cell and the non-serving cell.

A hysteresis value per cell may be added. For example, the hysteresis value applied to specific cells to be compared or to all or some cells may be added. In this case, a value in which the hysteresis value is added may be considered instead of the serving cell representative value and the specific cell representative value in the above examples. The network may configure the hysteresis value applied to specific cells or to all or some cells for the terminal.

When the above conditions are valid for a specific time, the corresponding condition may be satisfied. For example, when a specific time has passed since the terminal measured and started to satisfy the above conditions, the event triggered report may be transmitted. The BS may configure the specific time value for the terminal.

A report may be triggered when the above condition is met according to a specific configuration and remains satisfied and then the condition fails (like reportOnLeave).

Evaluation combinations are possible through distinction between SpCell and SCell. For example, in the examples above, those referred to as serving cells may be further distinguished and evaluated as SpCell and SCell. For example, SpCell representative value<SCell 1 representative value+offset.

The conditions for all other examples are also that, in the case of SpCell, the measure object may have to refer to a CSI resource within a serving cell group.

In the above conditions, the notation for the cell may be additionally distinguished as SpCell or SCell. For example, the cell value of SpCell may be larger or smaller than that of a specific SCell.

For the representative value per RS or beam (Option 2-1) in the previously proposed representative value derivation for each quantity, a threshold value or a relative offset of each quantity may be considered.

Event allows comparison between the value of a specific beam (RS/resource) or anonymous beam (or RS/resource) in a serving cell given the above measurement and report configuration (event triggered CSI measurement config and/or report config) and/or in another cell or different cell with the anonymous beam (or RS/resource) or the value of a beam/RS/resource of another cell. As in Option 1-1, various cases may be considered, including hysteresis and/or offset.

For example, (RS resource 1) of SpCell>cell 2+offset, RS resource 1 of SpCell<RS resource 2 of SCell 1+hysteresis

Beam 1 of SpCell>any other cells+offset

A hysteresis value per cell/RS may be added. The offset value and/or hysteresis value may be configured by the BS for the terminal.

When the event is satisfied and is valid for a specific time, the event triggered report transmission condition may be satisfied. The specific time value may also be configured by the BS for the terminal.

A report may be triggered when the above condition is met according to a specific configuration and maintained continuously and then the condition fails (like reportOnLeave operation).

Instead of the cells in the above conditions, an additional distinction of SpCell and/or SCell is possible. (In this case, the measure object must refer to a CSI resource within a serving cell group.)

For example, RS 1 of SpCell<SCell 1+offset+hysteresis.

In the derivation of the representative value by quantity, for the measurement value per RS/RS set, a comparison with the absolute value (e.g., consisting of one measurement value/comparison target and a threshold value) or a relative value (e.g., consisting of one or more measurement values/comparison targets and a difference value between the two) may be considered for the cell and/or RS measurement strength.

Absolute value: CSI-RS resource 1 of serving cell 1>threshold 1, and relative value: CSI-RS resource 2 of serving cell 1<CSI-RS 2 of serving cell 2+offset, CSI-RS resource set 2 of serving cell 1<CSI-RS resource 2 of specific cell 1.

In the case of comparisons between RSs, RS and cell, or cells, certain quantities other than RSRP/SINR are also possible as the quantity.

For example, CQI of serving cell 1>=threshold 1, CQI of RS resource 1 of serving cell 1<CQI of RS resource set 2 of specific cell 2, RI>4.

In the above example, multiple combinations of respective conditions, that is, AND combinations or OR combinations between conditions, may be used. Here, AND combination indicates that a measurement report can be transmitted if all conditions connected by AND must be satisfied. OR combination indicates that a measurement report can be transmitted if at least one of conditions connected by OR is satisfied.

For example, L1-RSRP of SpCell 1>SCell 1+offset AND RI of SCell 1>4

In the above case, not only the signal size but also the possibility of MIMO operation through a rank indicator may be included in the condition. Through comparison of such conditions, the possibility of a specific MIMO operation in a specific candidate cell may be considered in addition to typical situation recognition by cell strength.

The quantity, the type of condition (or event), and the absolute/relative value factors for comparison used in each condition required above may be indicated to the terminal in the CSI-RS report configuration, and may be linked to the report type indicator of the event triggered report or included in the IE (or field) of that indicator.

### Reporting Method and Contents

When the above disclosed evaluation conditions and/or combination of conditions are satisfied, the terminal may transmit an L1 meas report through the PUCCH or PUSCH via the serving cell in which the object to measure and the evaluation conditions are signaled.

By configuring the periodically distributed SSB/CSI-RS configured via RRC as the object to measure, the terminal may continuously measure periodically, evaluate the quantity metric periodically, and perform a report when the condition is satisfied. Alternatively, by configuring the aperiodically or semi-persistently distributed SSB/CSI-RS as the object to measure, the terminal may perform the measurement of the corresponding RS aperiodically or semi-persistently, and since the measurement sample created accordingly may be temporally aperiodic/semi-persistent, the terminal may also perform the evaluation aperiodically/semi-persistently. The trigger of the report according to the above evaluation is also possible.

The above report may include an ID indicating the object to measure, such as an ID of the considered SSB and/or CSI-RS resource, and an ID of a report Config in which the considered reportType (e.g., event triggered report) is indicated.

The terminal may attach and transmit the measurement result of the indicated quantity for the indicated object to measure. For example, when the object to measure is indicated to include only cells, the terminal may report including the indicated quantity values of the cells. Alternatively, if the object to measure includes cells and RSs of the cells, the terminal may include in the report the measurement results of the indicated quantity for the cells and the measurement results of the indicated quantity for the RSs of the cells. The following values may be included in the report.

### Measurement Values of the Indicated Quantity for all Cells of the Object to Measure

Indexes of all or some measurable CSI-RSs of the object to measure, an ID for a transmission cell of the RSs, and measured quantity values of resources/resource set corresponding to the RSS

The terminal may distinguish between a value for the object to measure that meets the condition that triggers the report and a value for other objects that do not, and it may report the values for the two types of objects. In this case, the serving BS may configure to report only the object that meets the condition, or to report all measured objects.

The BS may also pre-designate the target cell to which the report is transmitted.

For example, although the measurement configuration is indicated in serving cell 1, the event triggered report may be transmitted through another serving cell. If a certain serving cell has a more reliable UL, the transmission may be performed to that cell. In this case, the event triggered report may contain the previously configured resource config ID and/or report config ID, which the BS can use to distinguish the cell in which the CSI report configuration is configured.

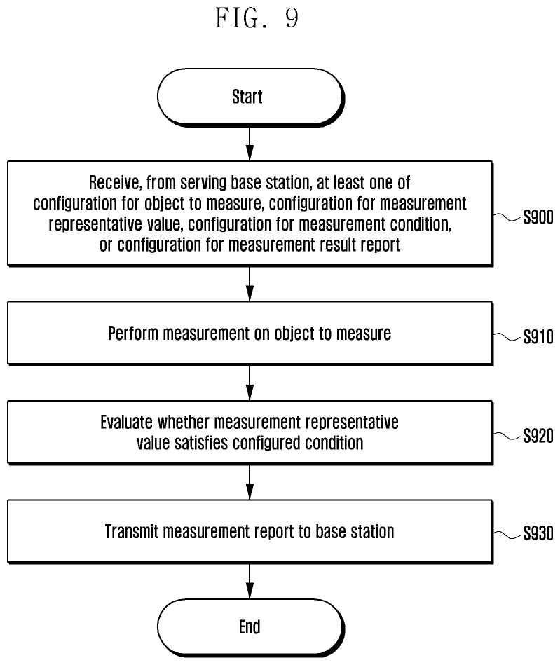

FIG. 9 illustrates operations performed by a terminal according to an embodiment.

Referring to FIG. 9, in S900, the terminal may receive, from a serving BS, at least one of a configuration for an object to measure, a measurement representative value, a measurement condition, or a measurement result report. All of the above configurations may be included in RRCReconfiguration or signaled to the terminal according to the above-described configuration methods for the object to measure.

Then, in S910, the terminal may perform measurement on the object to measure configured by the serving BS. If there is the configuration for the measurement representative value, the terminal may calculate the representative value by applying the configuration and maintain it within the terminal. In this case, the representative value may be continuously updated according to the finiteness/repetition of resources of the object to measure.

In step S920, the terminal may continuously evaluate whether the measurement representative value satisfies a condition given in the measurement condition configuration. When the given condition is satisfied at a specific time, the terminal may create a report in accordance with the configuration for the measurement result report.

In step S930, the terminal may transmit the created report to the serving BS based on the previously received report configuration.

Although in the above operations of the terminal all the configurations for the object to measure/measurement representative value/measurement condition/measurement result report are transmitted on RRCReconfiguration, the operations for measurement, evaluation, and reporting may be indicated via a separate DCI or a separate DL MAC CE since measurement and reporting may need to be performed dynamically.

Each block of the flowchart illustrations, and combinations of blocks in the flowchart illustrations, may be implemented by computer program instructions. These computer program instructions may be provided to a processor of a general purpose computer, special purpose computer, or other programmable data processing apparatus to produce a machine, such that the instructions, which are executed via the processor of the computer or other programmable data processing apparatus, generate means for implementing the functions specified in the flowchart block(s). These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart block(s). The computer program instructions may also be loaded onto a computer or other programmable data processing apparatus to cause a series of operational steps to be performed on the computer or other programmable apparatus to produce a computer implemented process such that the instructions that are executed on the computer or other programmable apparatus provide steps for implementing the functions specified in the flowchart block(s).

In addition, each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

The term unit, as used herein, refers to a software or hardware component or device, such as a field programmable gate array (FPGA) or application specific integrated circuit (ASIC), which performs certain tasks. However, a unit is not limited to software or hardware and may be configured to reside on an addressable storage medium and configured to execute on one or more processors. Thus, a module or unit may include components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and units may be combined into fewer components or further separated into additional components and modules and may be implemented to operate one or more central processing units (CPUs) in a device or a secure multimedia card. The unit may include one or more processors.

Thus, the methods according to embodiments described herein may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments as disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. A plurality of such memories may be included in the electronic device.

The programs may be stored in an attachable storage device which may access the electronic device through communication networks such as the Internet, Intranet, LAN, wide LAN (WLAN), and storage area network (SAN) or a combination thereof. Such a storage device may access the electronic device via an external port. A separate storage device on the communication network may access a portable electronic device.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method performed by a terminal in a wireless communication system, the method comprising:
receiving, from a base station, a control message including configuration information for an event triggered layer 1 (L1) measurement report including at least one of information on a resource for a reference signal (RS), at least one identity of at least one candidate cell for a lower layer triggered mobility (LTM) associated with the RS, or information on at least one event for reporting a measurement result;
measuring a serving cell and the at least one candidate cell for the LTM based on the configuration information; and
transmitting, to the base station, the measurement result based on the information on the at least one event.

2. The method of claim 1, further comprising:
identifying whether a measurement result for the serving cell is worse than a first absolute threshold value based on the configuration information,
wherein the first absolute threshold value is included in the information on at least one event for reporting the measurement result, and
wherein the measurement result is transmitted based on a result of the identification.

3. The method of claim 1, further comprising:
identifying whether a measurement result for the at least one candidate cell corresponds to an amount of an offset better than a measurement result for the serving cell based on the configuration information,
wherein information on the offset is included in the information on at least one event for reporting the measurement result, and
wherein the measurement result is transmitted based on a result of the identification.

4. The method of claim 1, further comprising:
identifying whether a measurement result for the at least one candidate cell is better than a second absolute threshold value based on the configuration information,
wherein the second absolute threshold value is included in the information on at least one event for reporting the measurement result, and
wherein the measurement result is transmitted based on a result of the identification.

5. The method of claim 1, further comprising:
identifying whether a measurement result for the serving cell is worse than a third absolute threshold value and a measurement result for the at least one candidate cell is better than a fourth absolute threshold value based on the configuration information,
wherein the third absolute threshold value and the fourth absolute threshold value are included in the information on at least one event for reporting the measurement result, and
wherein the measurement result is transmitted based on a result of the identification.

6. A method performed by a base station in a wireless communication system, the method comprising:
transmitting, to a terminal, a control message including configuration information for an event triggered layer 1 (L1) measurement report including at least one of information on a resource for a reference signal (RS), at least one identity of at least one candidate cell for a lower layer triggered mobility (LTM) associated with the RS, or information on at least one event for reporting a measurement result; and
receiving, from the terminal, the measurement result based on the information on the at least one event, in case that a serving cell and the at least one candidate cell for the LTM are measured based on the configuration information.

7. The method of claim 6,
wherein, whether a measurement result for the serving cell being worse than a first absolute threshold value is identified, by the terminal, based on the configuration information,
wherein the first absolute threshold value is included in the information on at least one event for reporting the measurement result, and
wherein the measurement result is received based on a result of the identification.

8. The method of claim 6,
wherein, whether a measurement result for the at least one candidate cell corresponding to an amount of an offset better than a measurement result for the serving cell is identified, by the terminal, based on the configuration information,
wherein information on the offset is included in the information on at least one event for reporting the measurement result, and
wherein the measurement result is transmitted based on a result of the identification.

9. The method of claim 6,
wherein, whether a measurement result for the at least one candidate cell being better than a second absolute threshold value is identified, by the terminal, based on the configuration information,
wherein the second absolute threshold value is included in the information on at least one event for reporting the measurement result, and
wherein the measurement result is transmitted based on a result of the identification.

10. The method of claim 6,
wherein, whether a measurement result for the serving cell being worse than a third absolute threshold value and a measurement result for the at least one candidate cell being better than a fourth absolute threshold value is identified, by the terminal, based on the configuration information,
wherein the third absolute threshold value and the fourth absolute threshold value are included in the information on at least one event for reporting the measurement result, and
wherein the measurement result is transmitted based on a result of the identification.

11. A terminal in a wireless communication system, the terminal comprising:
a transceiver; and
at least one processor configured to:
receive, from a base station via the transceiver, a control message including configuration information for an event triggered layer 1 (L1) measurement report including at least one of information on a resource for a (RS), at least one identity of at least one candidate cell for a lower layer triggered mobility (LTM) associated with the RS, or information on at least one event for reporting a measurement result,
measure a serving cell and the at least one candidate cell for the LTM based on the configuration information, and
transmit, to the base station via the transceiver, the measurement result based on the information on the at least one event.

12. The terminal of claim 11, wherein the at least one processor is further configured to:
identify whether a measurement result for the serving cell is worse than a first absolute threshold value based on the configuration information,
wherein the first absolute threshold value is included in the information on at least one event for reporting the measurement result, and
wherein the measurement result is transmitted based on a result of the identification.

13. The terminal of claim 11, wherein the at least one processor is further configured to:
identify whether a measurement result for the at least one candidate cell corresponds to an amount of an offset better than a measurement result for the serving cell based on the configuration information,
wherein information on the offset is included in the information on at least one event for reporting the measurement result, and
wherein the measurement result is transmitted based on a result of the identification.

14. The terminal of claim 11, wherein the at least one processor is further configured to:
identify whether a measurement result for the at least one candidate cell is better than a second absolute threshold value based on the configuration information,
wherein the second absolute threshold value is included in the information on at least one event for reporting the measurement result, and
wherein the measurement result is transmitted based on a result of the identification.

15. The terminal of claim 11, wherein the at least one processor is further configured to:
identify whether a measurement result for the serving cell is worse than a third absolute threshold value and a measurement result for the at least one candidate cell is better than a fourth absolute threshold value based on the configuration information,
wherein the third absolute threshold value and the fourth absolute threshold value are included in the information on at least one event for reporting the measurement result, and
wherein the measurement result is transmitted based on a result of the identification.

16. A base station in a wireless communication system, the base station comprising:
a transceiver; and
at least one processor configured to:
transmit, to a terminal via the transceiver, a control message including configuration information for an event triggered layer 1 (L1) measurement report including at least one of information on a resource for a reference signal (RS), at least one identity of at least one candidate cell for a lower layer triggered mobility (LTM) associated with the RS, or information on at least one event for reporting a measurement result, and
receive, from the terminal via the transceiver, the measurement result based on the information on the at least one event, in case that a serving cell and the at least one candidate cell for the LTM are measured based on the configuration information.

17. The base station of claim 16,
wherein, whether a measurement result for the serving cell being worse than a first absolute threshold value is identified, by the terminal, based on the configuration information,
wherein the first absolute threshold value is included in the information on at least one event for reporting the measurement result, and
wherein the measurement result is received based on a result of the identification.

18. The base station of claim 16,
wherein, whether a measurement result for the at least one candidate cell corresponding to an amount of an offset better than a measurement result for the serving cell is identified, by the terminal, based on the configuration information,
wherein information on the offset is included in the information on at least one event for reporting the measurement result, and
wherein the measurement result is transmitted based on a result of the identification.

19. The base station of claim 16,
wherein, whether a measurement result for the at least one candidate cell being better than a second absolute threshold value is identified, by the terminal, based on the configuration information,
wherein the second absolute threshold value is included in the information on at least one event for reporting the measurement result, and
wherein the measurement result is transmitted based on a result of the identification.

20. The base station of claim 16,
wherein, whether a measurement result for the serving cell being worse than a third absolute threshold value and a measurement result for the at least one candidate cell being better than a fourth absolute threshold value is identified, by the terminal, based on the configuration information,
wherein the third absolute threshold value and the fourth absolute threshold value are included in the information on at least one event for reporting the measurement result, and
wherein the measurement result is transmitted based on a result of the identification.
